(19) United States
(12) Patent Application Publication
(10) Pub. No.: US 2026/0348305 A1
(43) Pub. Date: Nov. 5, 2026

(54) SECURING DEVICE FOR SECURING A TURBOMACHINE

(71) Applicant: Accelleron Switzerland Ltd, Baden (CH)

(72) Inventors: Philippe PANDOLFO, Wettingen (CH); Detlef BEHRENDT, Küssaberg (DE); Tobias VOGT, Rickenbach (DE)

(21) Appl. No.: 19/488,268

(22) PCT Filed: May 16, 2024
(86) PCT No.: PCT/EP2024/063488

§ 371 Date: Nov. 26, 2025

(30) Foreign Application Priority Data
Jun. 1, 2023 (EP) 23176844.1

(51) Int. Cl. F01D 25/28

(52) U.S. Cl. CPC F01D 25/28

(57) ABSTRACT

Disclosed is a securing device for securing a turbomachine, in particular a turbocharger, to a base. The securing device comprises at least one leg that can be secured to the base. The securing device also comprises a first interlocking element located on a first side of the securing device for establishing an interlocking and rotationally fixed connection to a corresponding interlocking element of a first casing of the turbomachine without using additional securing means, and a plurality of securing-means receptacles for receiving securing means in order to secure the first casing to the securing device. The securing device additionally comprises a second interlocking element located on a second side of the securing device for establishing an interlocking connection, which blocks movements in the vertical direction, to a corresponding interlocking element of a second casing of the turbomachine without using additional securing means. The securing device is made in one piece.

### TECHNICAL FIELD

The invention relates to the field of turbomachines, in particular of fastening devices for fastening turbomachines, for example turbochargers, to a base.

### TECHNICAL BACKGROUND

Fastening devices for mounting a turbomachine, in particular a turbocharger, on a base or a foundation play a crucial role for the stability and security of the installation. Here, a number of important technical aspects must be observed in conjunction with the fastening devices.

In general, the turbomachine, for example a turbocharger, is mounted on a foundation or a base in order to ensure stability and rigidity. The foundation should be strong enough and robust enough to bear the weight of the turbomachine and minimize vibrations. The fastening devices are then used to securely anchor the turbomachine on the foundation.

The most common method for fastening a turbomachine to a base is the use of screws or bolts. These are inserted into prepared threaded bores or anchoring means in the foundation or in the base. It is important to use high-strength screws or bolts which offer the tightening torque and strength required to securely hold the turbomachine.

To minimize the transmission of vibrations and oscillations, use is often made of elastic or damping elements. These elements may be rubber or elastomer pads, spring elements or special vibration dampers. They serve to decouple the turbomachine from the vibrations of the foundation and create a quieter and more stable operating environment.

For the mounting of a turbomachine, it is important to ensure the correct orientation and alignment. This ensures optimum performance and reduces wear of and damage to the components. Adjustable fastening devices can be used in order to adjust the orientation of the turbomachine and ensure that it is fixed in the correct position.

Furthermore, the fastening devices must be capable of withstanding the occurring loads. Aside from the weight of the turbomachine, it is also necessary to take into account dynamic loads such as vibrations, shocks or thermal expansion in order to ensure secure and reliable installation.

It has been found that the fastening devices that are known from the prior art for turbomachines have certain disadvantages with regard to dismounting and mounting, and still have potential for improvement in terms of their load capacity.

It is therefore an object of the present invention to provide a fastening device for turbomachines, by means of which fastening device one or more of the disadvantages known from the prior art can be partially or fully overcome.

### BRIEF DESCRIPTION OF THE INVENTION

To solve the aforementioned object, a fastening device for fastening a turbomachine, and a turbomachine, according to the independent claims are provided. Further aspects, advantages and features of the present invention can be found in the dependent patent claims, the description and the appended figures.

According to one aspect of the invention, a fastening device for fastening a turbomachine, in particular a turbocharger, to a base is provided. The fastening device comprises at least one foot, which is fastenable to the base. The fastening device furthermore comprises a first interlocking element, arranged on a first side of the fastening device, for forming an interlocking and rotationally fixed connection with a corresponding interlocking element of a first housing of the turbomachine without the use of additional fastening means. The fastening device also comprises a plurality of fastening-means receptacles, arranged on the first side, for receiving fastening means for fastening the first housing to the fastening device. The fastening device also comprises a second interlocking element, arranged on a second side of the fastening device, for forming an interlocking and vertically secured connection with a corresponding interlocking element of a second housing of the turbomachine without the use of additional fastening means. The fastening device is formed as one piece.

The present invention provides an improved fastening device for fastening a turbomachine. In particular, the embodiments of the fastening device described herein allow easier mounting and dismounting of a turbomachine, in particular a turbocharger. The fastening device is designed such that, in the first mounting step, at least one housing of the turbomachine can be connected to the fastening device, securely in a vertical direction, without additional fastening means. Furthermore, at least one housing of the turbomachine can be connected rotationally fixedly to the fastening device without the need for additional fastening means. During a dismounting process, the second housing remains secured in the vertical direction even after the first housing has been released from the fastening device. Furthermore, the fastening device according to the described embodiments improves the load capacity of the fastening of a turbomachine to a base. The fastening device described herein is particularly advantageous for turbomachines, in particular turbochargers, with a cartridge concept.

According to a second aspect of the invention, a turbomachine is provided. The turbomachine comprises a first housing, a second housing and a fastening device according to one of the embodiments described herein for fastening the turbomachine. The first interlocking element of the fastening device forms an interlocking and rotationally fixed connection with a corresponding interlocking element of the first housing of the turbomachine. The first housing is connected, at the fastening device, by a plurality of fastening means to the fastening device. The plurality of fastening means engage with the fastening-means receptacles arranged on the first side. The second interlocking element forms an interlocking and vertically secured connection with a corresponding interlocking element of the second housing of the turbomachine.

### BRIEF DESCRIPTION OF THE FIGURES

The invention will be discussed below on the basis of exemplary embodiments which are illustrated in figures and from which further advantages and modifications will become apparent. In the figures:

FIG. 1 shows a perspective view of a fastening device according to embodiments described herein;

FIG. 2 shows a schematic perspective sectional view of a fastening device according to embodiments described herein, together with a first housing and a second housing of a turbomachine connected to said fastening device; and

FIG. 3 shows a schematic axial sectional view of a detail of a turbomachine, in particular of a turbocharger, according to embodiments described herein.

### DETAILED DESCRIPTION OF THE FIGURES

Various embodiments, of which one or more examples are illustrated in each figure, will be described below. Each example serves for explanatory purposes and is not to be understood as limiting. For example, features that are illustrated or described as being part of one embodiment may be used on or in conjunction with any other embodiment in order to obtain a further embodiment. It is intended that the present disclosure includes such modifications and variations.

In the following description of the figures, identical or similar components are denoted by the same reference signs. In general, only the differences in relation to the individual embodiments will be described. Unless stated otherwise, the description of a part or aspect in one embodiment can also relate to a corresponding part or a corresponding aspect in another embodiment.

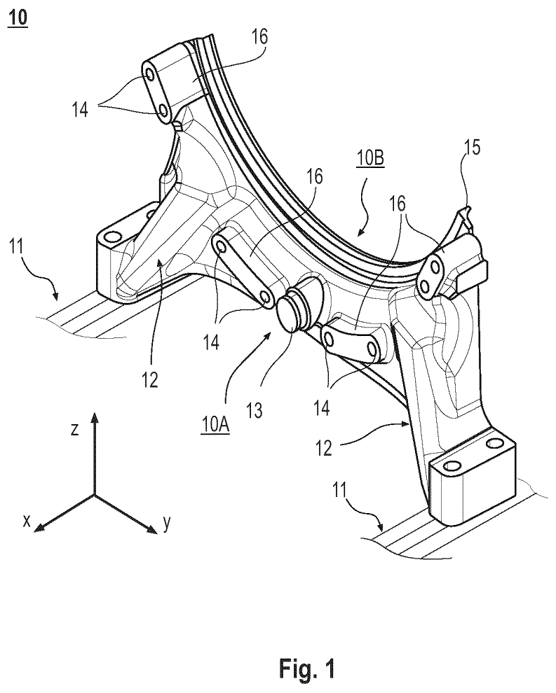

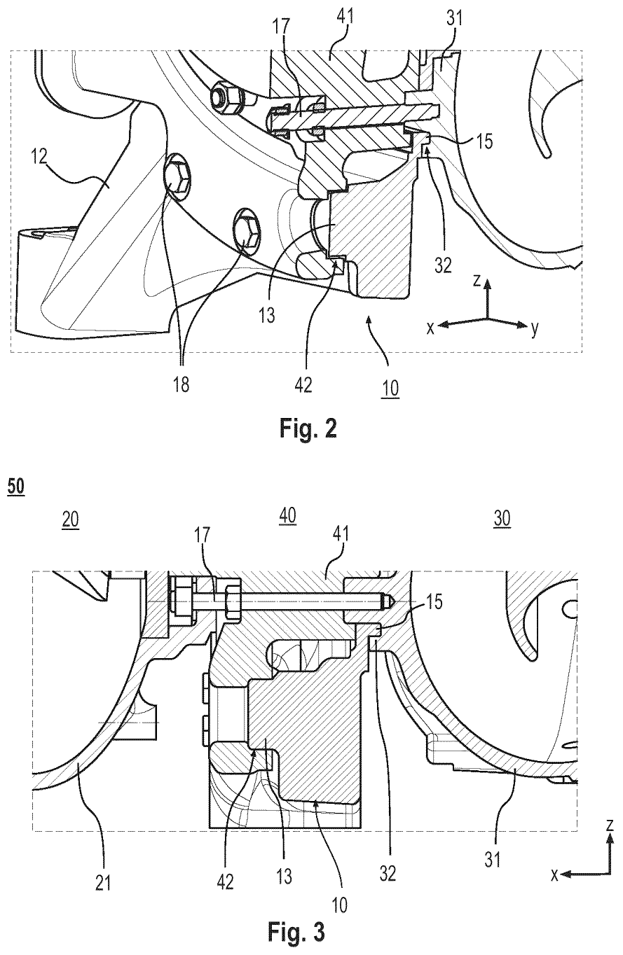

A fastening device 10 for fastening a turbomachine, in particular a turbocharger, to a base 11, according to the present disclosure, will be described with reference to FIGS. 1 and 2. The coordinate system shown in FIGS. 1 to 3 indicates the vertical direction z, the axial direction x and the lateral direction y, to which reference will be made in the present disclosure.

In one embodiment, which can be combined with other embodiments described herein, the fastening device 10 comprises at least one foot 12, which is fastenable to the base 11. FIG. 1 shows an example with two feet 12. The fastening device 10 furthermore comprises a first interlocking element 13, which is arranged on a first side 10A of the fastening device 10. The first interlocking element 13 is designed to form an interlocking and rotationally fixed connection with a corresponding interlocking element 42 of a first housing 41 of the turbomachine. The interlocking and rotationally fixed connection can be provided without the use of additional fastening means. The fastening device 10 also comprises a plurality of fastening-means receptacles 14, arranged on the first side 10A, for receiving fastening means for fastening the first housing 41 to the fastening device 10. The fastening device 10 also comprises a second interlocking element 15, which is arranged on a second side 10B of the fastening device 10. The second interlocking element 15 is designed to form an interlocking and vertically secured connection with a corresponding interlocking element 32 of a second housing 31 of the turbomachine. The interlocking and vertically secured connection can be provided without the use of additional fastening means. The fastening device is typically formed as one piece.

It is thus advantageously the case that a fastening device for fastening a turbomachine is provided which is improved in relation to the prior art. In particular, the embodiments of the fastening device described herein allow easier mounting and dismounting of a turbomachine, in particular a turbocharger. The fastening device is advantageously designed such that, during the mounting of a first housing and of a second housing of the turbomachine on the fastening device, in a first mounting step at least one housing of the turbomachine can be connected to the fastening device so as to be secured in a vertical direction without the use of additional fastening means. Furthermore, the fastening device is advantageously designed such that at least one housing of the turbomachine can be connected rotationally fixedly to the fastening device without the use of additional fastening means. The fastening device according to the embodiments described herein furthermore has the advantage that, during a dismounting process, the second housing remains secured in the vertical direction after the first housing has been released from the fastening device. Furthermore, the fastening device according to the embodiments described herein allows a turbomachine to be fastened to a base in an improved manner in terms of load capacity. The fastening device described herein is particularly advantageous for turbomachines, in particular turbochargers, with a cartridge concept.

The cartridge concept in the context of turbomachines refers to a design in which the core of the turbomachine is designed as an independent unit, which can be referred to as a cartridge. Said cartridge typically comprises one or more impellers, for example a compressor wheel and/or a turbine wheel, and the associated bearing arrangements. In the context of turbochargers, the cartridge concept refers to a design in which the turbocharger is divided into a plurality of components or modules. Each module performs a specific function and can be serviced or exchanged independently of the other modules.

In the cartridge concept, the turbocharger is typically divided into three main components. The turbine housing can be regarded as a first main component. The turbine housing is that part of the turbocharger which comes into contact with the hot exhaust gases. The turbine housing surrounds the turbine wheel. The compressor housing of the compressor which is responsible for compressing the fresh air in the turbocharger can be regarded as a second main component. The compressor housing surrounds the compressor wheel. The compressor housing is connected to the intake system of the engine and can be exchanged separately from the turbine housing. The cartridge can be regarded as a third main component. The cartridge is the actual core part of the cartridge concept. The cartridge comprises one or more impellers, for example the compressor wheel and/or the turbine wheel, and the bearing units. The cartridge is regarded as an independent unit and can be fully uninstalled and exchanged without the need to remove the turbine or compressor, which makes the servicing and repair of the turbocharger easier.

In the present disclosure, a “fastening device for fastening a turbomachine to a base” can be understood to mean a special structure which serves to securely and stably fasten a turbomachine in its intended position on the base. The “base” is typically a stable platform or structure to which the turbomachine is fastened. In particular, the base serves as a foundation or support on which the fastening device is installed in order to securely hold the turbomachine. The base may consist of various materials such as steel, concrete or other stable construction materials, depending on the specific requirements of the application and the forces that act on the turbomachine.

A “foot, which is fastenable to a base”, of the fastening device can be understood to mean a fastening device part which is directly connectable to the base and serves as a contact surface. Said foot allows the fastening device to be stably fastened to the base. The foot may assume different shapes and sizes depending on the design and requirements of the fastening device. The foot typically consists of a robust and durable material such as steel or some other high-strength alloy. The foot may have a flat, circular, rectangular or other suitable bearing surface in order to ensure good stability and secure hold on the base. The foot is typically equipped with fastening holes or threads in order to allow simple and secure fastening to the base. Screws, bolts or other fastening elements can be inserted through said holes or threads in order to fixedly connect the foot to the base. The main function of the foot which is fastenable to a base consists in anchoring the fastening device on the base and providing a solid base for the turbomachine or some other component. The foot contributes to transmitting, to the base, the forces and loads that can occur during operation, and at the same time to ensuring the stability, orientation and security of the device. The foot which is fastenable to the base may be an integral constituent part of the fastening device.

In the present disclosure, an “interlocking element” may be understood to mean an element, component or structure of the fastening device which is configured to establish secure interlocking between two or more parts. The first interlocking element 13 refers to a particular component or structure of the fastening device which serves to produce an interlocking and rotationally fixed connection with the corresponding interlocking element 42 of the first housing 41 of the turbomachine. The special design of the first interlocking element 13 is typically dependent on the specific construction and the design of the turbomachine. Said first interlocking element may be a groove, a peg, a pin, a bolt, a tongue-and-groove connection, a toothing or some other form of structural element that exhibits a tight fit or complementarity with the corresponding interlocking element 42. The technical function of the first interlocking element 13 consists in producing an interlocking connection in which the two parts, the first interlocking element 13 and the corresponding interlocking element 42 of the first housing 41, interact with one another and fit into one another in order to ensure a rotationally fixed connection. A rotationally fixed connection can be understood to mean a connection which is designed such that the two connected parts are prevented from rotating relative to one another.

The second interlocking element 15 refers to a particular component or structure of the fastening device which serves to produce an interlocking and vertically secured connection with a corresponding interlocking element 32 of a second housing 31 of the turbomachine. As in the case of the first interlocking element 13, the specific design of the second interlocking element 15 is typically dependent on the specific construction and the design of the turbomachine. Said second interlocking element may be a groove, a peg, a pin, a bolt, a tongue-and-groove connection, a toothing or some other form of structural element that exhibits a tight fit or complementarity with the corresponding interlocking element 32. The technical function of the second interlocking element 15 consists in producing an interlocking connection in which the two parts, the second interlocking element 15 and the corresponding interlocking element 32 of the second housing 31, interact with one another and fit into one another in order to ensure a connection which is designed such that the connection is secured in a vertical direction. A connection which is secured in a vertical direction can be understood to mean a connection which is designed such that an undesired movement or displacement of the two connected parts in the vertical direction is prevented.

As can be seen from FIG. 1, the second side 10B, on which the second interlocking element 15 is arranged, of the fastening device is a side facing away from the first side 10A. In particular, the first side 10A and the second side 10B are mutually averted and opposite sides. “Mutually averted and opposite sides” can be understood to mean sides of the fastening device which, with regard to their orientation and positioning, are situated opposite one another and face in opposite directions.

In one embodiment, which can be combined with other embodiments described herein, the first interlocking element 13 extends in an axial direction. For example, the first interlocking element 13 may be a pin or a peg, and the corresponding interlocking element 42 of the first housing 41 may be a matching pin receptacle or peg receptacle. Alternatively, the corresponding interlocking element 42 of the first housing 41 may be a pin or a peg, and the first interlocking element 13 of the fastening device 10 may be a matching pin receptacle or peg receptacle. An outer contour of the pin or of the peg may be round, oval, circular, polygonal (for example triangular, tetragonal, pentagonal etc.) or have some other suitable outer contour geometry. Accordingly, an inner contour of the pin receptacle or peg receptacle may be round, oval, circular, polygonal (for example triangular, tetragonal, pentagonal etc.) or have some other suitable inner contour geometry.

In one embodiment, which may be combined with other embodiments described herein, the second interlocking element 15 extends axially in the opposite direction in relation to the first interlocking element 13, as illustrated by way of example in FIGS. 1 to 3. For example, the second interlocking element 15 may be an axial, arcuate, in particular partially circular, projection, and the corresponding interlocking element 32 of the second housing 31 may be an axial, arcuate, in particular partially circular, groove. Alternatively, the corresponding interlocking element 32 of the second housing 31 may be an axial, arcuate, in particular partially circular, projection, and the second interlocking element 15 may be an axial, arcuate, in particular partially circular, groove. As can be seen from FIGS. 1 and 2, the arcuate, in particular partially circular, design refers to an arcuate or partially circular curvature about an axis in the axial direction x.

It is pointed out that, although the figures illustrate only a first interlocking element 13 and a second interlocking element 15, it is also possible in alternative embodiments for two or more first interlocking elements and/or two or more second interlocking elements to be provided. Accordingly, it is also possible for two or more corresponding interlocking elements 42 to be provided on the first housing 41 and/or for two or more corresponding interlocking elements 32 to be provided on the second housing 31.

In one embodiment, which may be combined with other embodiments described herein, the plurality of fastening-means receptacles 14 are arranged in an arcuate, in particular partially circular, configuration on the first side 10A of the fastening device 10. In other words, the fastening-means receptacles 14 may be arranged along a virtual arc, in particular along a virtual circular segment. As illustrated by way of example in FIG. 1, the fastening-means receptacles typically extend in the axial direction x. FIG. 2 shows a schematic perspective sectional view of the fastening device 10, which has been connected to a first housing 41 and a second housing 31. FIG. 2 also shows, by way of example, fastening means 18 by which the first housing 41 is fastened to the fastening device 10.

In the present disclosure, “fastening-means receptacles” can be understood to mean specific elements or structures which serve to receive or fasten fastening means such as screws, bolts, rivets or other fastening elements. The fastening-means receptacles are typically an integral part of the fastening device.

In one embodiment, which may be combined with other embodiments described herein, the plurality of fastening-means receptacles 14 are arranged in one or more protruding elements 16. The plurality of protruding elements 16 typically extend in the axial direction x, as shown by way of example in FIG. 1. In an example illustrated in FIG. 1, two or more protruding elements 16 each having at least one fastening-means receptacle 14, in particular two fastening-means receptacles 14, are provided.

In one embodiment, which may be combined with other embodiments described herein, the first interlocking element 13 is arranged centrally between the plurality of fastening-means receptacles 14, as illustrated by way of example in FIG. 1.

A one-piece design of the fastening device can be understood to mean that the fastening device is produced as a single, undivided part or component. This means that the fastening device contains no separate parts or elements that have to be connected to one another. A fastening device of one-piece design be manufactured as a single part, either by casting, forming or machining of a single material. There are no additional connections, weld seams or assembly steps required to produce the fastening device. The advantage of a fastening device of one-piece design lies in its simplicity and its high structural integrity. Owing to the absence of connection points or intermediate elements, there is a lower risk of weak points or faults in the fastening device. This can advantageously lead to higher strength, reliability and longevity.

In one embodiment, which can be combined with other embodiments described herein, the first housing 41 is a bearing housing. A “bearing housing of a turbomachine” can be understood to mean a housing of the turbomachine which serves to receive and protect the bearings for the rotors and shafts of the turbomachine. A turbomachine, for example a turbocharger, typically comprises various rotating parts which are mounted on bearings in order to allow low-friction and reliable rotation.

In one embodiment, which can be combined with other embodiments described herein, the second housing 31 is a turbine housing. A “turbine housing” can be understood to mean a housing of the turbomachine which encloses and protects the turbine components such as rotor and guide vanes.

A turbomachine 50 according to the present disclosure will be described with reference to FIG. 3. In one embodiment, which may be combined with other embodiments described herein, the turbomachine comprises a first housing 41, a second housing 31, and a fastening device 10 according to one of the embodiments described herein for fastening the turbomachine 50. The first interlocking element 13 of the fastening device 10 forms an interlocking and rotationally fixed connection with a corresponding interlocking element 42 of the first housing 41 of the turbomachine 50. The first housing 41 is connected, at the fastening device 10, by a plurality of fastening means 18 to the fastening device 10. The plurality of fastening means 18 engage with the fastening-means receptacles 14 arranged on the first side 10A. The second interlocking element 15 forms an interlocking and vertically secured connection with a corresponding interlocking element 32 of the second housing 31 of the turbomachine 50.

In one embodiment, which can be combined with other embodiments described herein, the turbomachine is a turbocharger. The first housing 41 may be a bearing housing. The second housing 31 may be a turbine housing. Typically, the turbocharger comprises a compressor having a compressor housing 21, comprises a turbine 30 having the turbine housing 31, and comprises an inner bearing 40 which is arranged between the compressor housing 21 and the turbine housing 31 and which has the bearing housing 41. For example, the compressor housing 21 may be connected by at least one connecting means 17, which extends through the bearing housing 41, to the turbine housing 31, as illustrated by way of example and FIGS. 2 and 3.

As is apparent from the embodiments described herein, the invention advantageously provides a fastening device for a turbomachine, said fastening device being improved in terms of mounting/dismounting and load capacity.

### LIST OF REFERENCE SIGNS

10 Fastening device
10A First side of the fastening device
10B Second side of the fastening device
11 Base
12 Foot
13 First interlocking element
14 Fastening-means receptacles
15 Second interlocking element
16 Protruding elements
17 Connecting means
18 Fastening means
20 Compressor
21 Compressor housing
30 Turbine
31 Second housing, in particular turbine housing
32 Corresponding interlocking element of the second housing
40 Inner bearing
41 First housing, in particular bearing housing
42 Corresponding interlocking element of the first housing
50 Turbomachine, in particular turbocharger
x Axial direction
Z Vertical direction
y Lateral direction

1-12. (canceled)

13. A fastening device for fastening a turbomachine to a base, comprising:
at least one foot, which is fastenable to the base,
a first interlocking element, arranged on a first side of the fastening device, for forming an interlocking and rotationally fixed connection with a corresponding interlocking element of a first housing of the turbomachine without the use of additional fastening means,
a plurality of fastening-means receptacles, arranged on the first side, for receiving fastening means for fastening the first housing to the fastening device, and
a second interlocking element, arranged on a second side of the fastening device, for forming an interlocking and vertically secured connection with a corresponding interlocking element of a second housing of the turbomachine without the use of additional fastening means, wherein the fastening device is formed as one piece.

14. The fastening device as claimed in claim 13, wherein the first interlocking element is a pin or a peg, and the corresponding interlocking element of the first housing is a matching pin receptacle or peg receptacle, or vice versa.

15. The fastening device as claimed in claim 13, wherein the second interlocking element is an axial, arcuate projection, and the corresponding interlocking element of the second housing is an axial, arcuate groove, or vice versa.

16. The fastening device as claimed in claim 13, wherein the second interlocking element is an axial, partially circular projection, and the corresponding interlocking element of the second housing is an axial, partially circular groove, or vice versa.

17. The fastening device as claimed in claim 13, wherein the plurality of fastening-means receptacles are arranged in an arcuate configuration on the first side.

18. The fastening device as claimed in claim 13, wherein the plurality of fastening-means receptacles are arranged in a partially circular configuration on the first side.

19. The fastening device as claimed in claim 13, wherein the plurality of fastening-means receptacles are arranged in one or more protruding elements.

20. The fastening device as claimed in claim 13, wherein the first interlocking element is arranged centrally between the plurality of fastening-means receptacles.

21. The fastening device as claimed in claim 13, wherein the first housing is a bearing housing.

22. The fastening device as claimed in claim 13, wherein the second housing is a turbine housing.

23. The fastening device as claimed in claim 13, wherein the turbomachine is a turbocharger.

24. A turbomachine, comprising:
a first housing,
a second housing, and
a fastening device for fastening the turbomachine, the fastening device (10) comprising:
at least one foot, which is fastenable to the base,
a first interlocking element, arranged on a first side of the fastening device, for forming an interlocking and rotationally fixed connection with a corresponding interlocking element of a first housing of the turbomachine without the use of additional fastening means,
a plurality of fastening-means receptacles, arranged on the first side, for receiving fastening means for fastening the first housing to the fastening device, and
a second interlocking element, arranged on a second side of the fastening device, for forming an interlocking and vertically secured connection with a corresponding interlocking element of a second housing of the turbomachine without the use of additional fastening means, wherein the fastening device is formed as one piece,
wherein the first interlocking element of the fastening device forms an interlocking and rotationally fixed connection with a corresponding interlocking element of the first housing of the turbomachine,
wherein the first housing is connected, at the fastening device, by a plurality of fastening means to the fastening device, wherein the plurality of fastening means engage with fastening-means receptacles arranged on the first side, and
wherein the second interlocking element forms an interlocking and vertically secured connection with a corresponding interlocking element of the second housing of the turbomachine.

25. The turbomachine as claimed in claim 24, wherein the turbomachine is a turbocharger, wherein the first housing is a bearing housing, and wherein the second housing is a turbine housing.

26. The turbomachine as claimed in claim 25, wherein the turbocharger comprises a compressor having a compressor housing,
comprises a turbine having the turbine housing, and
comprises an inner bearing which is arranged between the compressor housing and the turbine housing and which has the bearing housing.

27. The turbomachine as claimed in claim 26, wherein the compressor housing is connected by at least one connecting means, which extends through the bearing housing, to the turbine housing.
